(19) United States
(12) Patent Application Publication
(10) Pub. No.: US 2019/0169053 A1
(43) Pub. Date: Jun. 6, 2019

(54) Water-Soluble Encapsulated Clarifying Agent

(71) Applicant: NC Brands L.P., Norwalk, CT (US)

(72) Inventor: Scott Schaneville, St. Petersburg, FL (US)

(73) Assignee: NC Brands L.P.

(21) Appl. No.: 15/829,451

(22) Filed: Dec. 1, 2017

(51) Int. Cl. C02F 1/56; C02F 1/52; C02F 1/68

(52) U.S. Cl. CPC C02F 1/56; C02F 1/5227; C02F 2303/04; C02F 1/688; C02F 1/5272

(57) ABSTRACT

The present invention is directed to materials and method of encapsulating chemical agents. In particular, the present invention is directed to compositions and methods of encapsulating a coagulant or flocculant in a water soluble polymer encapsulant.

### FIELD OF THE INVENTION

The present invention relates to water soluble films and encapsulants.

### BACKGROUND OF THE INVENTION

In general, coagulants and flocculants such as polyacrylamides are used to treat contaminated bodies of water in order to bind to contaminants and make it easier for removal via filtrations or other methods, thus allowing for the water to return to a clean and clear state.

Polyacrylamides are also safe for treatment of bodies of water such as a pool, jacuzzi, spa, lakes, and other bodies of water where humans might swim and come in contact with the treated water.

Typically such compounds are used in a pure state or as a mixture with other chemicals in order to treat bodies of water. It has to be insured that the polyacrylamide is compatible with the other chemicals if used in such fashion, and that the polyacrylamide with still be able to act as a coagulant when applied to water for treatment. When mixed with other compound there is the potential for the polymer backbone to be broken thus rendering the polyacrylamide in effective. In addition, other compounds can react and change the function group on the polyacrylamide thus changing the chemical structure of polyacrylamide. As such, there is a need for materials and methods for delivering coagulants and flocculants such as polyacrylamides, to contaminated bodies of water that maintain the effectiveness of the coagulants and flocculants.

### SUMMARY OF THE INVENTION

The present invention broadly encompasses materials and methods for encapsulating clarifying agents.

The present invention further contemplates materials and methods for encapsulating coagulants and flocculants in water soluble films.

One embodiment of the present invention contemplates a composition comprising a water-soluble polymeric encapsulant; and a coagulant or flocculant encapsulated in the water soluble polymer encapsulant.

In some embodiments of the present invention, the coagulant or flocculant comprises a polyacrylamide.

In certain embodiments, the coagulant or flocculant may comprise sodium dichloroisocyanurate.

Embodiments of the present invention may be formulated in a unit or pod dosage form.

In embodiments of the present invention, the water-soluble polymeric encapsulant may be water-soluble film.

In embodiments of the present invention, the water-soluble polymeric encapsulant may be a flexible water-soluble film.

In certain embodiments of the present invention, the water-soluble polymeric encapsulant is a self-supporting water-soluble film.

The present invention provides embodiments where the coagulant or flocculant may be stable or inert with respect to the water-soluble polymeric encapsulant.

The present invention also provides embodiments where the water-soluble polymeric encapsulant renders the encapsulated coagulant or flocculant stable or inert.

Embodiments of the present invention may also further comprise one or more of: an active compound, a disinfectant, an antimicrobial, a sporocide, a stabilizing agent, and a colorant.

Water-soluble polymeric encapsulants in accordance with the present invention may also be configured to provide timed release of the encapsulated coagulant or flocculant over a period of about 1 minute to about 4 weeks.

Water-soluble polymeric encapsulants in accordance with the present invention may also be configured to provide time-delayed release of the encapsulated coagulant or flocculant with a release time beginning from about 1 minute to about 4 weeks.

The present invention also encompasses embodiments where the water-soluble polymeric encapsulant may be formed into a plurality of films, at least a first film in the plurality of films encapsulating the coagulant or flocculant, and a second film in the plurality of films encapsulating nothing, or one or more of the coagulant or flocculant, an active compound, a disinfectant, an antimicrobial, a sporocide, a stabilizing agent, and a colorant.

Embodiments of the present invention may also comprise a plurality of films configured for sequential dissolution.

In certain embodiments of the present invention, the water-soluble polymeric encapsulant may be formed into a plurality of films, at least a first film in the plurality of films encapsulating the coagulant or flocculant, and a second film in the plurality of films encapsulating one or more of the coagulant or flocculant, an active compound, a disinfectant, an antimicrobial, a sporocide, a stabilizing agent, and a colorant, the plurality of films being configured for sequential dissolution effective to sequentially release an encapsulant in each of the plurality of films.

In some embodiments of the present invention, the water-soluble polymeric encapsulant comprises one or more polymers, plasticizers, emulsifiers, bonding agents, bulking agents, fillers, and stabilizing agents.

Some embodiments of the present invention may have a density greater than 1 gram per cc.

Some embodiments of the present invention may have a density less than 1 gram per cc.

Embodiments of the present invention may be formed in a unit dose configuration effective to enclose one or more hollow pocket that give the composition an effective density less than 1 gram per cc.

Embodiments of the present invention further comprise methods having the steps of providing a composition, comprising:a water-soluble polymeric encapsulant; and a coagulant or flocculant encapsulated in the water soluble polymer encapsulant; and clarifying a portion of water by contacting the composition to the portion of water effective to cause at least partial dissolution of the water-soluble polymeric encapsulant effective to release the encapsulated coagulant or flocculant to the portion of water.

### DETAILED DESCRIPTION OF THE INVENTION

In the following detailed description, embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

In general, coagulants and flocculants such as polyacrylamides are used to treat contaminated bodies of water in order to bind to contaminants and make it easier for removal via filtrations or other methods, thus allowing for the water to return to a clean and clear state.

Polyacrylamides are also safe for treatment of bodies of water such as a pool, jacuzzi, spa, lakes, and other bodies of water where humans might swim and come in contact with the treated water.

Typically such compounds are used in a pure state or as a mixture with other chemicals in order to treat bodies of water. It has to be insured that the polyacrylamide is compatible with the other chemicals if used in such fashion, and that the polyacrylamide with still be able to act as a coagulant when applied to water for treatment. When mixed with other compound there is the potential for the polymer backbone to be broken thus rendering the polyacrylamide in effective. In addition, other compounds can react and change the function group on the polyacrylamide thus changing the chemical structure of polyacrylamide.

For the purposes of this invention, polyacrylamides are incorporated into a water soluble film in order to provide an additional benefit and effect when using such film. Typically such films are composed of polyvinylalcohol (PVA) with no additional components to such films. Since PVA based films can be used to form pods to deliver various desired chemicals to treat various bodies of water, polyacrylamides can be incorporated into the film in a uniform and functional manner, thus allowing for an additional effect to the application. This also cuts back on the need to havecoagulants and flocculants to be administered separately or mixed with other compounds when applied thus saving time and avoiding potential compatibility issues.

The present invention aims to provide a PVA based film with a coagulant such as polyacrylamides incorporated uniformly into the film, providing water clarification treatment with each application of such films. PVA based films can be used to form pods that are filled with various chemicals for the treatment of a pool, jacuzzi, spa, lakes, and other bodies of water where humans might swim and come in contact with the treated water. Such bodies of water are desired to be clean and clear, thus the highly beneficial effect of having a water clarifier incorporated into the water soluble film regardless of the chemical that is filled into the pod. This allows for consistent application of water clarifier, and provide a more consistent methods of maintaining water clarity.

The present invention provides a film and a method of forming same. The film can be divided into equally sized units having substantially equal amounts of each compositional component present. This advantage is particularly useful because it permits large area films to be initially formed, and subsequently cut into individual units without concern for whether each unit is compositionally equal. For example, the films of the present invention have particular applicability as delivery systems for polyacrylamides and other coagulants and flocculants. In one aspect of the invention, there is provided a self-supporting film composition including atleast one carrier (PVA), at least one active agent (polyacrylamide). The agent can be a large scale particle, for example, a macromolecule, or individual molecules. The agent can also be a small-scale particle, for example, a microparticle or a nanoparticle, or individual molecules.

In one embodiment, the agent (polyacrylamide) can be prepared into an emulsion that is formed into a film. The agent can be present within the film from 0.1% to 60% by weight of the film.

The agent can be prepared into an emulsion, such emulsion can be prepared from a matrix forming polymer (e.g., PVA, mixture of various PVA grades, Pullulan or the like) and with or without a surfactant (e.g., polysorbate or the like) and a plasticizer (e.g., glycerin or the like) mixed together in an aqueous solution (e.g., water). Various emulsion preparation techniques can be used in the process, such as sonication, mixing, or the like. The composition can be heated at temperature ranges of 40 F to 250 F, or 60 F-180 F, or about 100 F for a period of 5-45 minutes, or 10-35 minutes or about 30 minutes to dissolve the agent and form the emulsion. A suspension may also be formed. The emulsion may be degassed prior to forming the film. The degassing can be performed in open air or with vacuum.

The emulsion can be then cast into a film. The processing can by any processing that can take an emulsion and form it into a film, which processing steps are not limited to those describedherein. Examples can include extrusion, solution casting box apparatus, reverse roll coating casting, and other solution casting apparatus' known to those skilled in the art of solution casting. In this embodiment, the modified emulsion can be passed between rollers (e.g., casting rollers), and rolled onto a substrate at the desired wet gauge thickness. The substrate can be a wax or silicone coated substrate that allows the film to be peeled therefrom once the film is stable. The rollers can be adjusted to change the gap there between to change the wet gauge thickness of the film. Once on the substrate, the film can be cured and solidified, such as by heating. In one example, the film on the substrate can be passed through a heater (e.g., infrared heater) with air flow to provide convection heating, which is regulated to remove moisture from the film. The film can be formed in this matter to inhibit rippling or other unfavorable characteristics, and may avoid blistering. Good throughout heating and curing can produce the desired film.

A similar method may also be used without the formation of an emulsion, and by the dry mixing of the film components, and the use of extrusion methods to mix all components and the formation of a film.

The emulsion for eventual film formation can be formed in such a method. The reaction vessel is preheated and water is added to the vessel. PVA is then added very slowly to the heated water under stirring, taking care to ensure full dissolving of material before additional amounts are added. Once the PVA emulsion matrix is formed, the polyacrylamide is then added to the mixture, also ensuring slow addition to avoid clumping. Then sodium dodecyl sulfate and glycerin added to achieve the desired thickness of emulsion and the emulsion is then poured out of the vessel and collected. The mixture is then allowed to cool and degas. Once at room temperature the mixture can then be cast and final film is formed.In one example, the emulsion is prepared by heating the reaction vessel to approximately 160 F. The reaction vessel is heated through the use of recirculated water through the water jacket on the reaction vessel. Water is then added to the reaction vessel and the mehcanical stirrer is set to 400 RPMs. Care has to be taken to ensure that the reaction vessel is sealed, and that minimalexposure to the outside is achieved in order to avoid contaminants entering and water vapor from escaping.

Once the water has reached a temperature of 160 F, the granulated 88% grade PVA (polymer matrix) powder is slowly added to the stirring water. The stirring is gradually increased to 600 RPM as more of the PVA is added to the vessel. Once the emulsion looks uniform the polyacrylamide (coagulant/water clarifier) is then added to the stirring emulsion thus incorporating it into the PVA emulsion. Additional compounds such as sodium dodecyl sulfate (surfactant) and glycerin (plasticizer) are added to achieve a desired consistency of the emulsion and eventually the cast film. The mixture is then poured out of the reaction vessel and collected. The emulsion is allowed to cool down to room temperature and to degas in open air for 1 hour, then sealed and allowed to degas overnight. This emulsion is then cast and the final film is formed by any method known tto those skilled in the art of solution casting.

In other instances the components that make up the eventual final film might be substituted one at a time or all at once, the following are a list of alternatives that may achieve similar desired water soluble films that can encapsulate the coagulant/water clarifier.

Alternative polymers that can be used individually or in combination:

Poly(2-hydroxypropyl methacrylate), Poly(-ethyl-2-oxazoline) [MW 200,000], Poly(2-ethyl-2-oxazoline) [MW 500,000], Poly(2-ethyl-2-oxazoline) [MW 500,000], Polyacrylamide (MW 400,000-1,000,000), Poly(3-chloro-2-hydroxypropyl-2-methacryloxyethyldimethylammoniumchloride), Poly(acrylamide/2-methacryloxyethyltrimethylammonium bromide) 80:20, 20% aq. Soln., Poly(vinylamine) hydrochloride, Poly(1-lysine hydrobromide) [MW 80,000] 0.1% Solution, Poly(2-vinylpyridine) [MW 300,000-400,000], Poly(4-vinylpyridine), Poly(ethylene oxide-b-propylene oxide) [ratio 0.33:1], Poly(ethylene oxide-b-propylene oxide) [ratio 0.8:1], Poly(ethylene oxide-b-propylene oxide), Poly(methacrylic acid), Poly(methacrylic acid) sodiumsalt, 30% soln. in water, Polypropylene, Isotactic, Poly(vinyl methyl ether), 50% methanol solution, Poly(styrenesulfonic acid), sodium salt (MW 1,000,000), Poly(N-methyl N-vinyl acetamide) homopolymer, Poly(n-butyl acrylate/2-methacryloxyethyltrimethylammonium bromide) 80:20, Dextran, Poly(vinylsulfonic acid) sodium salt, 25% soln. in water, Dextran, DEAE ether, Cellulose, methyl hydroxyethyl ether, Dextran, hydrogenated, Poly(acrylamide/acrylic acid), potassium salt, crosslinked, Poly(vinyl methyl ether), 50% aqueous solution, Poly(oxyethylene) sorbitan monolaurate (Tween 20®), Poly(vinyl alcohol) [MW˜108,000], Poly(vinyl alcohol) [98 mol. % hydrolyzed], Dextran, Dextran [MW 100,000-200,000], Dextran [MW 200,000-300,000], Dextran [MW 3,000,000-7,000,000], Cellulose,hydroxyethyl ether (MW 1,000,000), Cellulose, hydroxyethyl ether (MW 720,000), Cellulose, hydroxyethyl ether (MW˜90,000), Poly(ethylene oxide) [MW 100,000], Poly(acrylic acid), 63% soln. in water [MW˜2,000], Poly(N-iso-propylacrylamide), Poly(Allyl Amine), Mw 15,000, Poly(2-hydroxyethyl methacrylate/methacrylic acid) 90:10, Poly(acrylamide/acrylic acid) [60:40], Polymethacrylamide, Poly(2-methacryloxyethyltrimethylammonium bromide), 20% soln. in water, Poly(N-vinylpyrrolidone), MW 10,000, Poly(N-vinylpyrrolidone), Pharmaceutical grade, MW 40,000, Poly(2-vinylpyridine) [MW 200,000-400,000], Poly(2-vinylpyridine) [MW 40,000], Poly(N-vinylpyrrolidone/2-dimethylaminoethyl methacrylate), dimethyl sulfate quaternary, Poly(4-vinylpyridine N-oxide), Guar Gum, Poly(ethylene oxide-b-propylene oxide) [ratio 0.15:1], Poly(ethylene oxide-b-propylene oxide) [ratio 0.15:1], Poly(ethyl acrylate/acrylic acid), Poly(ethylene/acrylic acid) 92:8, Poly(acrylic acid), sodium salt, 40% soln. in water [MW˜3,000], Poly(acrylic acid), powder [MW 4,000,000], Poly(acrylic acid), ammonium salt, powder [MW 250,000], Poly(vinyl phosphoric acid), sodium salt, Poly(styrenesulfonic acid), sodium salt (MW 75,000), Poly(N-vinylpyrrolidone/vinyl acetate) [70:30], Poly(N-vinylpyrrolidone/vinyl acetate) [50:50], Poly(N-vinylpyrrolidone/vinyl acetate) [30:70], Poly(N-vinylpyrrolidone), MW 4,000-6,000, Poly(acrylic acid), sodium salt, crosslinked, Poly(ethylene oxide) [MW 200,000], Poly(ethylene oxide) [MW 5,000,000], Poly(1-lysine hydrobromide) [MW 275,000], Poly(diallyldimethylammonium chloride) [MW˜240,000], Powder, Poly(2-vinyl-1-methylpyridinium bromide), 20% soln. in water, Poly(4-vinylpyridine), Poly(ethylene oxide-b-propylene oxide) [ratio 3:1], Poly(styrenesulfonic acid/maleic acid), sodium salt, Poly(methacrylic acid) ammonium salt, 30% soln. in water, Poly(acrylic acid), powder [MW˜1,000,000], Poly(acrylic acid), sodium salt, powder (MW˜2,000), Poly(vinyl acetate), Poly(vinyl acetate), 40% hydrolyzed, Poly(ethylene oxide) [MW 300,000], Poly(ethylene oxide) [MW 600,000], Dextran sulfate, sodium salt, Poly(ethylene oxide) [MW 8,000,000], Poly(vinyl alcohol) [MW 78,000], Poly(vinyl alcohol) [88 mol. % hydrolyzed], Poly(1-glycerol methacrylate), Polyacrylamide (MW 5,000,000), 1% aq soln, Poly(butadiene/maleic acid) 1:1, 42% soln. in water, Poly(acrylic acid), sodium salt, powder [MW˜6,000], Polypropylene, Poly(ethylene oxide) [MW 4,000,000], Poly(vinyl alcohol) [MW 133,000], Poly(vinyl alcohol) [MW˜25,000], Poly(2-ethyl-2-oxazoline) [MW 50,000], Poly(1-lysine hydrobromide) [MW 50,000], Poly(N-vinylpyrrolidone), MW 40,000, Poly(N-vinyl acetamide), Poly(2-ethyl-2-oxazoline) [MW 5,000], Poly(acrylamide/sodium acrylate) [70:30], Chitosan, Purified Powder MW˜15,000, Poly(acrylic acid), 25% soln. in water [Mw˜345,000], Poly(acrylic acid), sodium salt, 20% soln. in water [MW˜225,000], Poly(ethylene oxide) [MW 1,000,000], Poly(acrylic acid), sodium salt, 35% soln, in water [MW˜60,000], Poly(acrylic acid), powder [MW 450,000], Poly(styrenesulfonic acid), 30% soln. in water, Polypropylene, Chromatographic Grade, Poly(N-vinylpyrrolidone), MW 2,500, Poly(1-lysine hydrobromide) [MW 120,000], Poly(Diallyl Dimethyl Ammonium Chloride) [Mw˜8,500], 28 wt. % in H2O, Poly(acrylamide/acrylic acid), Poly(vinyl alcohol), N-methyl-4(4′-formylstyryl)pyridinium methosulfate acetal, Poly(vinylphosphonic acid), 30% Soln., Poly(vinyl alcohol) [MW 6,000], Poly(N-vinylpyrrolidone), MW 1,000,000, Poly(acrylic acid), 50% soln. in water [MW˜5,000], Poly(vinyl alcohol) [MW 25,000], Poly(acrylic acid), 25% soln. in water [MW˜50,000]

Alternative Plasticizers:

Glycerol/glycerin; Propylene Glycol; Polyethylene glycol; Fatty acids; Vegetable oil; Vegetable shortening; Olive oil; Soybean oil; Grape seed oil; Sunflower oil; Peanut oil; Corn oil; Canola oil; Rice Bran oil; Lard; Suet; Butter or Coconut oil,

Alternative Surfactants:

Polysorbate 20 (polyoxyethylene (20) sorbitan 15 monolaurate); Polysorbate 40 (polyoxyethylene (20) sorbitan monopalmitate); Polysorbate 60 (polyoxyethylene (20) sorbitan monostearate); Polysorbate 80 (polyoxyethylene (20) sorbitan monooleate); Polyethylene glycol;Monoglycerides; Diglycerides; Triglycerides; Phospholipids; Lecithin; Sodium bis(2-ethylhexyl) sulfosuccinate (AOT); or sodium mono- and dimethylnaphthalene sulfonate (SMDNS).

Additional examples and data may be found in the Appendix attached hereto.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

1. A composition, comprising:
a water-soluble polymeric encapsulant; and
a coagulant or flocculant encapsulated in the water soluble polymer encapsulant.

2. The composition of claim 1, the coagulant or flocculant comprising a polyacrylamide.

3. The composition of claim 1, the coagulant or flocculant comprising sodium dichloroisocyanurate.

4. The composition of claim 1, formulated in a unit or pod dosage form.

5. The composition of claim 1, the water-soluble polymeric encapsulant being a water-soluble film.

6. The composition of claim 1, the water-soluble polymeric encapsulant being a flexible water-soluble film.

7. The composition of claim 1, the water-soluble polymeric encapsulant being a self-supporting water-soluble film.

8. The composition of claim 1, the coagulant or flocculant being stable or inert with respect to the water-soluble polymeric encapsulant.

9. The composition of claim 1, the water-soluble polymeric encapsulant rendering the encapsulated coagulant or flocculant stable or inert.

10. The composition of claim 1, further comprising one or more of: an active compound, a disinfectant, an antimicrobial, a sporocide, a stabilizing agent, and a colorant.

11. The composition of claim 1, the water-soluble polymeric encapsulant being configured to provide timed release of the encapsulated coagulant or flocculant over a period of about 1 minute to about 4 weeks.

12. The composition of claim 1, the water-soluble polymeric encapsulant being configured to provide time-delayed release of the encapsulated coagulant or flocculant with a release time beginning from about 1 minute to about 4 weeks.

13. The composition of claim 1, the water-soluble polymeric encapsulant being formed into a plurality of films, at least a first film in the plurality of films encapsulating the coagulant or flocculant, and a second film in the plurality of films encapsulating nothing, or one or more of the coagulant or flocculant, an active compound, a disinfectant, an antimicrobial, a sporocide, a stabilizing agent, and a colorant.

14. The composition of claim 13, the plurality of films being configured for sequential dissolution.

15. The composition of claim 1, the water-soluble polymeric encapsulant being formed into a plurality of films, at least a first film in the plurality of films encapsulating the coagulant or flocculant, and a second film in the plurality of films encapsulating one or more of the coagulant or flocculant, an active compound, a disinfectant, an antimicrobial, a sporocide, a stabilizing agent, and a colorant, the plurality of films being configured for sequential dissolution effective to sequentially release an encapsulant in each of the plurality of films.

16. The composition of claim 1, the water-soluble polymeric encapsulant comprising one or more polymers, plasticizers, emulsifiers, bonding agents, bulking agents, fillers, and stabilizing agents.

17. The composition of claim 1, the composition having a density greater than 1 gram per cc.

18. The composition of claim 1, the composition having a density less than 1 gram per cc.

19. The composition of claim 1, formed in a unit dose configuration effective to enclose one or more hollow pocket that give the composition an effective density less than 1 gram per cc.

20. A method, comprising:
providing a composition, comprising:
a water-soluble polymeric encapsulant; and
a coagulant or flocculant encapsulated in the water soluble polymer encapsulant;
and clarifying a portion of water by contacting the composition to the portion of water effective to cause at least partial dissolution of the water-soluble polymeric encapsulant effective to release the encapsulated coagulant or flocculant to the portion of water.

21. The method of claim 20, comprising providing the composition according to any of claims 1-19.

22. A method, comprising:
providing a water-soluble polymeric encapsulant;
providing a coagulant or flocculant; and
encapsulating the coagulant or flocculant in the water soluble polymer encapsulant.

23. The method of claim 22, comprising encapsulating the coagulant or flocculant in the water soluble polymer encapsulant to form the composition according to any of claims 1-19.

24. A kit, comprising:
a composition, comprising:
a water-soluble polymeric encapsulant; and
a coagulant or flocculant encapsulated in the water soluble polymer encapsulant; and instructions, the instructions directing a user to clarify a portion of water by contacting the composition to the portion of water effective to cause at least partial dissolution of the water-soluble polymeric encapsulant effective to release the encapsulated coagulant or flocculant to the portion of water.

25. The kit of claim 24, comprising the composition according to any of claims 1-19.
